(19) United States
(12) Patent Application Publication
(10) Pub. No.: US 2014/0282414 A1
(43) Pub. Date: Sep. 18, 2014

(54) METHOD AND SYSTEM FOR DEBUGGING OF A PROGRAM

(71) Applicant: CADENCE DESIGN SYSTEMS, INC., San Jose, CA (US)

(72) Inventors: Nadav Chazan, Ness Ziona (IL); Tal Tabakman, Tel Aviv (IL); Yonatan Ashkenazi, Rehovot (IL)

(73) Assignee: Cadence Design Systems, Inc., San Jose, CA (US)

(21) Appl. No.: 13/804,183

(22) Filed: Mar. 14, 2013

(51) Int. Cl. G06F 11/36

(52) U.S. Cl. CPC G06F 11/362
USPC 717/125

(57) ABSTRACT

A computer implemented method for debugging of a program may include parsing a code segment of the program, the code segment invoking one or a plurality of execution events during an execution of the program to derive a plurality of questions, each relating to an execution event of said one or a plurality of execution events, based on the parsing of the code segment and on information recorded during the execution of the program. The method may also include selecting one of the questions as a current question. The method may further include presenting in a user interface the current question with one or a plurality of causes related to the current question, and one or a plurality of other questions of said one or a plurality of questions for selection by the user.

### FIELD OF THE DISCLOSURE

The present disclosure relates to debugging, and more specifically to a method and system for debugging a program.

### BACKGROUND

Debugging is a methodological process to systematically search for anomalies or discrepancies (hereinafter—anomalies) in a computer program or a hardware design (hereinafter—program) and to fix them after the anomalies are found in the program.

Typically, debugging extends from finding and fixing small errors to lengthy and tedious data collecting, analysis and scheduling updates.

Debugging is a painstaking task that may involve long hours or days of searching for anomalies in a program. It involves human skills and typically depends on the programming language being used and the available debugging tools.

### SUMMARY

Disclosed are various embodiments, including a computer implemented method of debugging. The method may include parsing a code segment of the program, the code segment invoking one or a plurality of execution events during an execution of the program to derive a plurality of questions, each relating to an execution event of said one or a plurality of execution events, based on the parsing of the code segment and on information recorded during the execution of the program. The method may further include selecting one of the questions as a current question. The method may also include presenting in a user interface the current question with one or a plurality of causes related to the current question, and one or a plurality of other questions of said one or a plurality of questions for selection by the user.

In some embodiments the method may further include presenting in the user interface a view of at least a portion of the code of the program, which includes the code segment of the program relating to the current question.

In some embodiments the method may also include obtaining a new selection by the user of a question of said one or a plurality of the other questions assigning it to be a new current question. The method may further include parsing a code segment of the program relating to the new current question, the code segment invoking one or a plurality of execution events during the execution of the program to derive a plurality of new questions, each relating to an execution event of said one or a plurality of execution events, based on the parsing of that code segment and on information recorded during the execution of the program. The method may still include presenting the new current question in the user interface with one or a plurality of causes related to the new current question, and one or a plurality of other questions of said one or a plurality of new questions for selection by the user.

The method may, according to some embodiments, include presenting in the user interface a view of at least a portion of the code of the program, which includes the code segment of the program relating to the new current question.

According to embodiments selecting the current question may be done automatically or manually by the user.

In some embodiments said one or a plurality of causes comprises one or a plurality of flow causes. In some embodiments said one or a plurality of causes comprises one or a plurality of value assignment or calculation causes.

According to an embodiment, there is provided a non-transitory computer readable storage medium, for debugging of a program. The non-transitory computer readable storage medium may have stored thereon instructions that when executed by a processor will cause the processor to perform the method of parsing a code segment of the program, the code segment invoking one or a plurality of execution events during an execution of the program to derive a plurality of questions, each relating to an execution event of said one or a plurality of execution events, based on the parsing of the code segment and on information recorded during the execution of the program; selecting one of the questions as a current question; and presenting in a user interface the current question with one or a plurality of causes related to the current question, and one or a plurality of other questions of said one or a plurality of questions for selection by the user.

Further according to some embodiments, there is provided a system for debugging of a program. The system may include a processing unit configured to parse a code segment of the program, the code segment invoking one or a plurality of execution events during an execution of the program to derive a plurality of questions, each relating to an execution event of said one or a plurality of execution events, based on the parsing of the code segment and on information recorded during the execution of the program; select one of the questions as a current question; and present in a user interface wthe current question with one or a plurality of causes related to the current question, and one or a plurality of other questions of said one or a plurality of questions for selection by the user.

### BRIEF DESCRIPTION OF THE DRAWINGS

FIG. 1 a method for debugging of a program according to an embodiment.

FIG. 2 illustrates a view of a user interface window, of a debugging tool according to embodiments.

FIG. 3 illustrates another view of a user interface window, of a debugging tool according to embodiments.

FIG. 4 illustrates yet another view of a user interface window, of a debugging tool according to embodiments.

FIG. 5 illustrates a system for debugging of a program according to an embodiment.

### DETAILED DESCRIPTION

In the following detailed description, numerous specific details are set forth in order to provide a thorough understanding of the methods and systems. However, it will be understood by those skilled in the art that the present methods and systems may be practiced without these specific details. In other instances, well-known methods, procedures, and components have not been described in detail so as not to obscure the present methods and systems.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

A debugging tool typically allows a programming expert (hereinafter—programmer) to follow the execution of a software program or an electronic hardware design (hereinafter, for the sake of brevity, collectively—program) and detect anomalies. Typically a debugging tool displays a source code or assembly code of the program under test on a user interface (hereinafter referred to as UI). The debugging tool offers various functions, such as performing break point setting, step execution, and the like. For example, in step execution using the UI, the debugging tool executes one or several lines of the source code or one instruction of the assembly code, and if there is a problematic code which leads to an error in a result of execution of the one instruction of the source code or assembly code, the debugging tool highlights a problematic portion or displays an auxiliary code, message, or the like which represents details of the error. The ability to examine an execution of a program step by step helps a human user to find anomalies (bugs) and fix them (debug).

A post-process debugging method was introduced which involves recording a specific program execution and allowing an on-line or off-line analysis of that execution. When recording the execution, all execution events that had occurred in that execution, such as, for example, function calls, values assigned for parameters of called functions, values assigned to variables, conditional statements, etc are saved. Information relating to the execution events encountered during an execution is saved (e.g., into a database, memory, etc.), allowing the review of the recorded execution in a user interface while mimicking the look and feel of a regular debugging tool. Thus, the human user (hereinafter—user) can go back and forth (up to the last execution event that was recorded) and view various execution events of that specific execution, including the related information of these events. Using such a post-process debug method allows the user to analyze any execution event and find the execution events that caused it to occur the way it did.

In such debugging method, the recording phase of the program being debugged may have ended or may have paused, and all the information that was collected regarding the execution of the tested program has been processed and stored. At that stage, the collected information is available and can help debug any previous point of time in the run of the program. It is noted, however that that the process of the program being debugged has not necessarily been terminated.

In the context of the present specification the terms “debugging” and “debugging tool” refer to debugging and debugging tools involving the recording of a specific execution of the program being debugged, or part of that program as explained hereinabove.

For example, consider the following program code, which may be debugged using a debugging tool, and presented to a user in a user interface of the debugging tool displayed on a display device:

73 goo( ): int {
74 if (my_value != calculate_value( ) {
75 var x:int = z + foo( );
76 ...

When the user reaches a certain operation (which may include one or a few lines), in this example—line 75 (“var x:int=z+foo( )”), the debugging tool knows that x is being assigned with the value 7, and it also knows that the reasons for that are: the fact that z was assigned with the value 4; and the fact that the result of foo( ) is 3.

Note that a debugging tool is typically capable not only of indicating that z was 4, but it may also tell when and where z got that value and the user can easily navigate to that exact execution event, with the look and feel of a “regular” debugging tool presented to the user notion as if that execution event is being currently executed. Knowing these two facts would generally be enough to explain the value assigned to x, but a user might want to know why did that particular execution reach the line where x is being assigned, and so more causes may be revealed—ones that relate to the logical flow that led to that line (for example “that line was reached because: an IF statement (in line 74) was reached 2; and the condition of that statement was evaluated to TRUE”). This type of information is sometimes referred to as “go to cause” or “cause and effect” analysis.

A previous, known implementation of a debugging tool with post-process capabilities presents the recorded execution events in a tree arrangement, where each node of the tree is the cause of its parent node and the effect of its child node. When the user requests the expansion of a particular node on that tree, the debugger calculates the causes of the selected execution event and adds them to the expanded node.

Another previous known implementation of a debugging tool with post-process capabilities which operates on a database of recorded execution events and their associated parameters is a source implementation, which includes parsing source lines and presenting parts of these lines which appear to have go-to-cause information in the form of links that allow the user to click those links and be transferred to source lines that are the “cause” of the clicked line link. Typically that implementation also presents the value of each parameter within the source code viewer.

Embodiments are aimed at providing a debugging tool with a user interface that allows reviewing, and navigating between, execution events of the execution run intuitively, allowing the user to focus on a current line of thought and explore it, while at the same time allowing diverting from that line of thought to another line of thought easily and quickly.

As used herein, debugging refers to any analysis of execution of a program whether or not the purpose of the analysis is to detect faulty operation (e.g., a bug) of the software program. A debugging tool refers to a software program or application, or to a collection or suite of such software programs or applications, that assists a user (e.g., a software developer) in performing such debugging. For example, a debugging tool may enable viewing various execution events during execution of the program being debugged. An “execution event”, in the context of the present disclosure, refers to any event that has occurred during the execution of the program, and may include, for example, a line that was executed, a routine that was called, a parameter that was calculated, a variable that has been assigned a value, a status of a computing environment, an indication (e.g., text, line, or location within a source code representation or other representation of the software program being debugged, a function currently being executed, an instruction that called the function being currently executed, or other indication) of an instruction that is being executed or that was most recently executed, an address of a variable or instruction, or other relevant information that may be displayed or otherwise made available to a user of the debugging tool, etc.

FIG. 1 illustrates a method 100 according to an embodiment. Method 100 may include parsing 102 a code segment of the program, the code segment invoking one or a plurality of execution events during an execution of the program. Method 100 may further include deriving 104 a plurality of questions, each relating to an execution event of said one or a plurality of execution events, based on the parsing of the code segment and on information recorded during the execution of the program. Method 100 may also include selecting 106 one of the questions and presenting 108 in a user interface for display on a display device the selected question with one or a plurality of causes related to the selected question, and one or a plurality of other questions of said one or a plurality of questions for selection by the user.

Parsing is conducted in order to analyze the syntax of the line being parsed so as to derive questions a user might have in conjunction with that line.

Different languages typically have different parsing tools, most have their own parsing engine within them and most of the time the syntax tree that is already created by these engines is queried. In some embodiments “parsing” would be accomplished by addressing an already present syntax tree or trees of the specific execution and not actually parsing the source code again.

Typically relevant questions would be, for example: “why was variable x assigned its present value?”, “why was parameter z calculated to have its current value?”, “where was the present routine called from?” etc.—questions that typically refer to the logical flow of the program or to the assignment or calculation of values. Other questions may be derived as well.

The cause or plurality of causes of the selected question may be presented in a separate section of the user interface (e.g., a frame or window) of the debugging tool, according to embodiments.

Said one or a plurality of other questions may also be presented in a separate section of the user interface (e.g., a frame or window) of the debugging tool, according to embodiments.

A method according to an embodiment may also include obtaining a selection by the user of a question of one or a plurality of the other questions of said one or a plurality of questions. Further, according to an embodiment, upon selection of that question, the user is presented with one or a plurality of causes associated with that question, and presenting one or a plurality of other questions relating to said one or a plurality of causes for further selection by the user.

According to some embodiments, parts of the line that are of interest in terms of go-to-cause may be indicated as selectable in such a way so as to allow the user to click (e.g., press a mouse button when the cursor is over a part of interest, which is indicated as selectable) or otherwise select these parts and invoke the presentation of related information that is the “cause” of the selected line part (hereinafter also—“answer”).

The method may also include presenting that question in the user interface for display on the display device with one or a plurality of answers associated with the execution events of that line relating to the newly selected question.

An answer to a current question may become a question itself. For example, in the example above the answer “z=4” can also be the question “why is z=4”. In accordance with some embodiments, when a user selects such an answer a view of the event where z was assigned the value 4 (for example the line that reads “var z:int=2+k”) is presented in a user interface. In some embodiments, at this point “why does z=4” may be presented as a current question, presenting “k=2” to be the only answer for the current question and offers further questions relevant to the execution event indicated as the current answer (“k=2”). There can be different types of questions. For example, flow questions (“why was line 75 reached?”, “why was method foo called?”, “why was this message printed?”) and value questions (“why does x=7?”). In many cases a single code line or a single execution event may relate to both types of questions. To help the user focus on one line of thought, in some embodiments, only one question is presented as a current question, and the other may be presented at the other questions area.

In some embodiments the current question may be related to the value assigned or calculated in the current code line. In some embodiments the other question or questions may relate to the logical flow of the program in its current execution that led to that line.

In some embodiments, the current question may be related to the logical flow of the program in its current execution that led to that line while the other question or questions would relate to the value assigned or calculated in the current code line.

As another example, consider the following code lines:

| | |
|---|---|
| 25 | if (config_on) { |
| 26 | out(“Configuration of swap_ab_inmux : |
| | ”,swap_ab_inmux ? “SWAP” : “NO_SWAP”, |
| | “Configuration of swap_ab_outmux : ”,swap_ab_outmux ? |
| | “SWAP” : “NO_SWAP”); |
| 27 | out(“Configuration of chnl_A_en : ”, |
| | channels[0].chnl_en ? “ENABLED” : “DISABLED”, |
| | “ Configuration of chnl_B_en : ”, channels[1].chnl_en ? |
| | “ENABLED” : “DISABLED”); |
| 28 | out(“Configuration of chnl_A_muter : ”, |
| | channels[0].muter_en ? “ENABLED” : “DISABLED”, |
| | “ Configuration of chnl_B_muter : ”, channels[1].muter_en ? |
| | “ENABLED” : “DISABLED”); |
| 29 | }; |

Assuming that the current line is selected to be line 27, the current question may be “why was line 25 reached”. The answers are 1) IF statement in line 25 was reached; and 2) Config_on=TRUE.

The facts that channels[0].chnl_en=TRUE and channels[1].chnl_en=FALSE are not answers to the current question, but they are both important facts. According to embodiments such elements are selected and placed in the section designated in the user interface of the debugging tool for the other questions.

The user may select (e.g. by clicking) one of the other questions and view of the code provided by the debugging tool would revert to the exact location in the execution where these fields were assigned with their values.

Yet another example may be considered with respect to the following code line: 45 var my_value: int=get_base_value(packet_color)+ to_add(my_address, my_size);

For the question “why does my_value=100?” there are two answers “get_base_value returned 60” and “to_add returned 40”, but a user (especially one that knows the program code under test) might also be interested in the values of the parameters these functions received. After reviewing these parameter values the user might decide that the most important question is “why my_size=7?” because user considers this as a ‘suspicious value’. The questions “why packet_color=RED?”, “why my_address=0xffff1111” and “why my_size=7?” may be placed in the other-questions section of the user interface (along with the question “why was line 45 reached?”).

Flow questions and value questions are essentially different.

Consider, for example, the following code lines of a program being debugged:

102 goo( ) is {
103 var x:int = z + foo( );
104 ...
105 }
224 foo( ): int is{
225 if (list_size > 100) {
226 error(“list size is too big”);
227 }
228 return list_size-5;
229 }

Assuming that list_size is 105 and an error message in line 226 was issued. The current question, according to embodiments may be: “why was the error reached?”—this is a flow question. The possible answers are: 1) IF statement in line 225 was reached; and 2) the condition was determined to be true.

If the user selects the second answer that would be in order to make a value investigation. The next question that may be presented to the user would be “why was the condition determined to true?” and the answer “list_size=105”. Following that path would help the user understand why list_size got its value and so on. Assuming the user selects the first answer, the new current question would be “why was the IF statement in line 225 reached?” and the answer is “method foo was called”. The user may select that answer and then the current user interface scope of the debugging tool is made to present line 103 with a flow-type question “why was method foo called?”. Notice that line 103 is the same line as line 76 from the detailed example discussed hereinabove. Another question may be asked about it is “why does x gets this or that value”, but since the user got to that line pursuing a flow line of investigation, the debugging tool, according to embodiments, may be configured to go on with that line of investigation, suggesting first flow type answers to the user, understanding that the user is currently uninterested about the value x got in the current line. The question about the value of x may be presented in the other questions section so as that in the event that the user changes his mind that question may be selected. Similarly other types (e.g., value type) of line of thought may be pursued. Thus, for example, same type further answers may be presented at the top of the list of answers, which are in fact other questions offered for investigation by the user.

According to embodiments the answers (causes) to questions may be classified into different types:

A. An execution event;

B. A static fact (this is not based on An execution event, rather it is just a true statement that explains something related to the question, or explains some other answer.

C. A possible cause (if the required information was not recorded, sometimes a certain answer cannot be provided, in such scenarios possible causes may be presented instead).

FIG. 2 illustrates a view offered by user interface 200, of a debugging tool according to embodiments.

Frame 202 presents a part of the code of the program being debugged (lines 40-59 are shown). Line 53 is currently selected, as indicated by arrow 208. In some embodiments the currently selected line may be highlighted or otherwise indicated as selected.

Line 53 of the code reads:

```
dut_error(“received  transfer  with  wrong  parity  -
      ”,  me,  “expected:  ”, hex(calculated_parity), “actual: ”,
      hex(parity));
```

After line 53 is parsed it may be determined, for example, that DUT error has been reached. Thus, according to embodiments this fact may be selected as a question and the question presented 210 in frame 204. Two answers 212 and 214, are offered for question 210, and presented below that question. Answer 212 states that IF statement in line 52 has been reached, whereas answer 214 indicates that value of condition was found to be true. In some embodiments the user may select one of the answers (e.g., by clicking on a clickable portion of the answer or otherwise selecting that answer, e.g., the text “goto if” at the end of each of answers 212 and 214). Consequently the view of the program as presented in frame 202 may change to show the portion of the code (e.g. a line or a few lines) of the program the answer relates to and/or select that portion, or even a portion of another file which is part of the logical flow debugged to which that answer relates. In the context of the present specification “the program” refers to a single file or a plurality of files which are part of a logical flow being debugged.

Other questions (e.g. questions 216, 218 and 220) relating to the selected line 53 may be presented to the user in frame 206. Each questions may be presented and configured to allow the user to select it, and upon selection of any of the other questions, that question would be become the “current question” and appear in frame 204, with its related answers.

FIG. 3 illustrates a view offered by user interface 300, of a debugging tool according to embodiments, showing only the current question and its answers.

View 302 of the user interface 300 of debugging tool presents code lines 57-73 of a program being debugged. A current line selection is indicated by arrow 304, showing that line 65 is currently selected. In some embodiments the selected line may be highlighted 305, or otherwise indicated as selected. Line 65 reads:

.parity=p_smp.port_parity$;

According to embodiments of the present disclosure, a question regarding the value of it.parity=0×85 (it.parity=0×85 because:) is presented in question section 306.

The first answer 308 is a static fact, as it is always true that the port p_smp.port_parity$ is bound to the signal m_parity, there is no execution event that made this connection. This answer is not clickable—it will not change the current view of the debugger, but it is necessary in order to understand the second answer. Had the first answer not been presented and had the only presented information been “value of it.parity=0×85 because m_parith=0×85”. The user would have not seen m_parity in the current scope, in fact m_parity is not even in the current source line and not even written in the same language as the language of the file viewed. This is why the static fact is so important—it explains that port_parity$ is connected to m_parity (meaning: whichever value m_parity gets it consequently becomes the value of port_parity$) and only now the second answer 310 can be understood.

FIG. 4 illustrates another view of a user interface window 400, of a debugging tool according to embodiments.

In this example, view 402 presents code lines 86-106 of a hardware design to be debugged. Line 97 is selected—this may be indicated, for example, by highlighting 404 the selected line, pointing an arrow or otherwise indicating the selection. Frame 424 is provided for presenting questions and answers according to the various embodiments of the present disclosure.

Frame 428 may be presented to the user by selecting an appropriate tab 422, from a selection of tabs 422, 420, 418, 416, which facilitate selection of frame 428 and other frames for viewing by the user.

Line 97 (and line 98 which is part of the same operation) reads:

parity_out <= #1 ! cha_read == 1 ? cha_parity :
chb_read == 1 ? chb_parity : 0;

In some embodiments it may so happen that not all information needed to determine where the value of parity_out was assigned has been recorded in the recording phase of the debugging tool. Recording such information may take considerable time and a skilled user may choose not to record it. The debugging tool may possess a-priori knowledge that there are only certain places (three in this example) in the code where this specific variable might have been assigned.

A possible question that relates to the assignment of value to parity_out may be: why is the value of m_parity=0×85? So that question may be selected as a current question and presented 406 in the current question section 426 of frame 424. Further, all three possible lines 86, 97 and 106 (marked 410, 412 and 414 respectively) relating to assignments for m_parity are presented below as possible causes (see mention of “possible cause” hereinabove). to the current question in section 428 of frame 424.

The user is thus offered to use his a-priory knowledge in selecting the assignment which is most likely to be the one that caused the value of m_parity to be 0×85. It should be noted that heuristics may be applied by the debugging tool, according to embodiments, in selecting the most likely relevant answer (in this example it is the second possibility—code line 97 marked 312 which is indicated in bold font).

It is noted that the question refers to m_parity, but the selected code line 404 refers to the assignment of parity_out. The reason for this is that the user was diverted to this view from the view shown in FIG. 3 by selecting the second answer in that view—so it is evident that the user is actually interested in the assignment of m_parity. m_parity is connected by wire to parity_out, which means that whenever parity_out is assigned a new value m_parity is consequently assigned the same value, thus this information is indicated in line 308 that m_parity is wired to parity_out.

In some embodiments the methods and systems described herein may be implemented for abstract debugging (encrypted code) and generation debugging (where no relevant source is present).

FIG. 5 illustrates a system 50 for debugging a program according to embodiments of the present disclosure. System 50 may include a processing unit 52 (e.g. one or a plurality of processors, on a single machine or distributed on a plurality of machines) for executing a method according to embodiments. Processing unit 52 may be linked with memory 56 on which a program implementing a method according and corresponding data may be loaded and run from, and storage device 58, which is a non-transitory computer readable medium (or mediums) such as, for example, one or a plurality of hard disks, flash memory devices, etc. on which a program implementing a method according and corresponding data may be stored. System 50 may further include display device 54 (e.g. CRT, LCD, LED etc.) on which one or a plurality user interfaces associated with a program implementing a method according and corresponding data may be presented. System 50 may also include input device 51, such as, for example, one or a plurality of keyboards, pointing devices, touch sensitive surfaces (e.g. touch sensitive screens), etc. for allowing a user to input commands and data.

Methods and systems according to embodiments may be used in various debugging scenarios, such as, for example debugging of circuit designs and other like language or context to plant support for electronic design applications, as well as other kinds of program debugging.

Examples may be embodied in the form of a system, a method or a computer program product. Similarly, examples may be embodied as hardware, software or a combination of both. Examples may be embodied as a computer program product saved on one or more non-transitory computer readable medium (or media) in the form of computer readable program code embodied thereon. Such non-transitory computer readable medium may include instructions that when executed cause a processor to execute method steps in accordance with examples. In some examples the instructions stores on the computer readable medium may be in the form of an installed application and in the form of an installation package.

Such instructions may be, for example, loaded by one or more processors and get executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

Examples are described hereinabove with reference to flowcharts and/or block diagrams depicting methods, systems and computer program products according to various embodiments.

Features of various examples discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the disclosure.

We claim:

1. A computer implemented method of debugging a program comprising:
parsing a code segment of the program, the code segment invoking one or a plurality of execution events during an execution of the program to derive a plurality of questions, each relating to an execution event of said one or a plurality of execution events, based on the parsing of the code segment and on information recorded during the execution of the program;
selecting one of the questions as a current question; and
presenting in a user interface the current question with one or a plurality of causes related to the current question and one or a plurality of other questions of said one or a plurality of questions for selection by the user.

2. The method of claim 1, further comprising presenting in the user interface a view of at least a portion of the code of the program, which includes the code segment of the program relating to the current question.

3. The method of claim 1, further comprising
obtaining a new selection by the user of a question of said one or a plurality of the other questions or a cause of said one or a plurality of causes and assigning it to be a new current question;
parsing a code segment of the program relating to the new current question, the code segment invoking one or a plurality of execution events during the execution of the program to derive a plurality of new questions, each relating to an execution event of said one or a plurality of execution events, based on the parsing of that code segment and on information recorded during the execution of the program; and
presenting in the user interface the new current question with one or a plurality of causes related to the new current question and one or a plurality of other questions of said one or a plurality of new questions for selection by the user.

4. The method of claim 3, further comprising presenting in the user interface a view of at least a portion of the code of the program, which includes the code segment of the program relating to the new current question.

5. The method of claim 1, wherein selecting the current question comprises selecting the question automatically.

6. The method of claim 1, wherein selecting the current question comprises selecting the question by the user.

7. The method of claim 1, wherein said one or a plurality of causes comprises one or a plurality of flow causes.

8. The method of claim 1, wherein said one or a plurality of causes comprises one or a plurality of value assignment or calculation causes.

9. A non-transitory computer readable storage medium, for debugging of a program, having stored thereon instructions that when executed by a processor will cause the processor to perform the method of:
parsing a code segment of the program, the code segment invoking one or a plurality of execution events during an execution of the program to derive a plurality of questions, each relating to an execution event of said one or a plurality of execution events, based on the parsing of the code segment and on information recorded during the execution of the program;
selecting one of the questions as a current question; and
presenting the current question in a user interface for display on a display device with one or a plurality of causes related to the current question, and one or a plurality of other questions of said one or a plurality of questions for selection by the user.

10. The non-transitory computer readable storage medium of claim 9, wherein the instructions when executed by the processor will cause the processor to further perform the method of:
presenting in the user interface a view of at least a portion of the code of the program, which includes the code segment of the program relating to the current question.

11. The non-transitory computer readable storage medium of claim 9, wherein the instructions when executed by the processor will cause the processor to further perform the method of:
obtaining a new selection by the user of a question of said one or a plurality of the other questions or a cause of said one or a plurality of causes and assigning it to be a new current question;
parsing a code segment of the program relating to the new current question, the code segment invoking one or a plurality of execution events during the execution of the program to derive a plurality of new questions, each relating to an execution event of said one or a plurality of execution events, based on the parsing of that code segment and on information recorded during the execution of the program; and
presenting the new current question in a user interface for display on a display device with one or a plurality of causes related to the new current question, and one or a plurality of other questions of said one or a plurality of new questions for selection by the user.

12. The non-transitory computer readable storage medium of claim 11, wherein the instructions when executed by the processor will cause the processor to further perform the method of:
providing of view of at least a portion of the code of the program, which includes the code segment of the program relating to the new current question.

13. The non-transitory computer readable storage medium of claim 9, wherein selecting the current question comprises selecting that question automatically.

14. The non-transitory computer readable storage medium of claim 9, wherein selecting the current question comprises selecting that question by the user.

15. The non-transitory computer readable storage medium of claim 9, wherein said one or a plurality of causes comprises one or a plurality of flow causes.

16. The non-transitory computer readable storage medium of claim 9, wherein said one or a plurality of causes comprises one or a plurality of value assignment or calculation causes.

17. A system for debugging of a program, comprising:
a processing unit configured to:
parse a code segment of the program, the code segment invoking one or a plurality of execution events during an execution of the program to derive a plurality of questions, each relating to an execution event of said one or a plurality of execution events, based on the parsing of the code segment and on information recorded during the execution of the program;
select one of the questions as a current question; and
present the current question in a user interface for display on a display device with one or a plurality of causes related to the current question, and one or a plurality of other questions of said one or a plurality of questions for selection by the user.

18. The system of claim 17, further comprising the display device.

19. The system of claim 17, wherein the processing unit is further configured to:
obtain a new selection by the user of a question of said one or a plurality of the other questions or a cause of said one or a plurality of causes and assign it to be a new current question;
parse a code segment of the program relating to the new current question, the code segment invoking one or a plurality of execution events during the execution of the program to derive a plurality of new questions, each relating to an execution event of said one or a plurality of execution events, based on the parsing of that code segment and on information recorded during the execution of the program; and
present the new current question in the user interface with one or a plurality of causes related to the new current question, and one or a plurality of other questions of said one or a plurality of new questions for selection by the user.

20. The system of claim 17, wherein the processing unit is further configured to present in the user interface a view of at least a portion of the code of the program, which includes the code segment of the program relating to the new current question.
